(19) United States
(12) Patent Application Publication
(10) Pub. No.: US 2015/0169285 A1
(43) Pub. Date: Jun. 18, 2015

(54) INTENT-BASED USER EXPERIENCE

(71) Applicant: Microsoft Corporation, Redmond, WA (US)

(72) Inventors: LORRISSA REYES, SEATTLE, WA (US); TYLER M. PEELEN, KIRKLAND, WA (US); LEI DU, REDMOND, WA (US); WILLIAM B. DOLAN, KIRKLAND, WA (US); BERNHARD S.J. KOHLMEIER, SEATTLE, WA (US); PRADEEP CHILAKAMARRI, REDMOND, WA (US); ANNIE Y. BAI, SEATTLE, WA (US)

(73) Assignee: Microsoft Corporation, Redmond, WA (US)

(21) Appl. No.: 14/133,093

(22) Filed: Dec. 18, 2013

(51) Int. Cl. G06F 3/16; G06F 3/0484; G06F 3/0482; G10L 17/22

(52) U.S. Cl. CPC G06F 3/167; G10L 17/22; G06F 3/04842; G06F 3/0482

(57) ABSTRACT

Techniques that facilitate the accomplishment of tasks within applications are presented. An intent-based user experience is available through receiving a natural language statement of intent from a user regarding use of an application, such as a productivity application. The graphical user interface for the user can be configured and reconfigured based on the user's intent; thus creating a task-oriented user interface. The user's intent can be determined through classifying and/or mapping the natural language statement of intent to particular tasks, which can then be associated with one or more tools and information that can be used to accomplish the tasks. The one or more tools and information can be surfaced to the user in the graphical user interface.

### BACKGROUND

Users are faced with an ever-increasing number of features and functions in today's complex software applications. When users wish to perform an operation in an application, they are often forced to search through long menus and nested sub-menus to find the desired command. Although the commands may be functionally grouped, the groupings (and location) of a particular command may not be grouped (or located) in a manner that makes sense to a user and, in any event, some operations require multiple commands that are placed on disparate menus and buttons.

Users sometimes turn to help interfaces to find the right command, but it can be difficult for users to find commands whose description they are unable to verbalize well enough to search for in help. In addition, neither hunting for commands in menus nor looking at search results allows users to discover new commands they might find useful. This can also be the case for commands or menus that do not surface unless the application is in a particular state. For example, certain commands (and menus) directed to editing an image may not appear unless an image is selected. Moreover, just as users begin to learn the placement of the commands they frequently use, a new version of the software application may be released that changes the user interface location of many commands and adds additional commands.

### BRIEF SUMMARY

Techniques that facilitate the accomplishment of tasks within applications are presented. A user experience is described in which a user can communicate a goal or intent related to a task by using a natural language statement and the relevant user interface elements can surface for use by the user in accomplishing the task. In this manner, a task-oriented reconfigurable interface can be provided for a variety of productivity applications.

Instead of searching for an application's commands and features through menus or button ribbons, an interaction surface enables the user to vocalize an intention to accomplish a given task or goal and receive the tools and information for accomplishing that task or goal. The vocalization can be a statement of a desired outcome, goal, problem, task, or other intent. That is, the user's statement can be effectively anything and does not require terms directly related to the names of a command (i.e., the command name or synonyms). The statement can be a natural language statement and the system interprets the natural language statement into an “intent” that is then mapped into elements including commands, features, and information that are available via one or more applications to the user.

The task-oriented reconfigurable interface can appear similar to more traditional graphical user interfaces available for a productivity application but with the addition of a pane, window, dropdown menu, box or other graphic element. While in other cases, the task-oriented reconfigurable interface can be rendered entirely based on the elements relevant to a user's determined intent.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a functional diagram for an intent-based user experience.

FIGS. 2A and 2B illustrate example representations of presentations of user interface elements for an intent-based user experience.

FIGS. 3A and 3B illustrate example initial views for implementing a task-oriented user interface for an intent-based user experience.

FIGS. 4A and 4B illustrate example interaction elements for receiving a natural language statement of an intent.

FIGS. 5A-5G illustrate example views of a task-oriented user interface surfaced in response to receiving a natural language statement of intent.

FIG. 6A illustrates an operating environment in which certain implementations of the intent-based user experience may be carried out.

FIG. 6B illustrates an example implementation enabling a generalized model for an application to publish its available intents and interface elements.

FIGS. 7A-7C illustrate views of a task-oriented user interface for an example scenario.

FIG. 8 depicts another example scenario of a task-oriented user interface.

FIG. 9 depicts yet another example scenario of a task-oriented user interface.

FIG. 10 is a block diagram illustrating components of a computing device or system used in some embodiments.

FIG. 11 illustrates example system architectures in which embodiments may be carried out.

### DETAILED DESCRIPTION

Techniques that facilitate the accomplishment of tasks within applications are presented.

In an example user experience described herein, relevant user interface commands can be presented in response to a natural language statement of a goal, or intent, communicated by a user. Embodiments described herein allow users to quickly find and utilize features, both within an application and across applications, relating to their intended goal. As used herein, a “natural language” statement refers to terminology that is intuitive to a user at any given moment. The statement (string, phrase, or other expression) may be based on written or spoken language structure and may include standardized and unstandardized aspects.

The subject techniques are suitable for productivity applications. A productivity application can include a variety of tools and information that can facilitate the accomplishment of a variety of tasks related to producing content.

Examples of productivity applications include the Microsoft Office® suite of applications from Microsoft Corp., including Microsoft Word®, Microsoft Excel®, Microsoft Powerpoint®, as well as the web application components thereof, all registered trademarks of Microsoft Corp.; Google Docs (and Google Drive™); the Apache OpenOffice™ available from the Apache Software Foundation; the LibreOffice® suite of applications available from The Document Foundation, registered trademarks of The Document Foundation; and the Apple iWork® suite of applications from Apple Inc, including Apple Pages®, Apple Keynote®, and Apple Numbers®, all registered trademarks of Apple Inc.

According to certain embodiments, a user interface for a productivity application is presented in a manner that provides a task oriented user experience. The task-oriented user experience presents user interface components in a manner suitable to address a particular task. Example user interface components (or elements) include, but are not limited to, commands, menus, input fields, icons, composition and interaction surfaces, and objects.

In some cases, a user interface element that may surface in a task-oriented user experience includes an element that calls or communicates with another application.

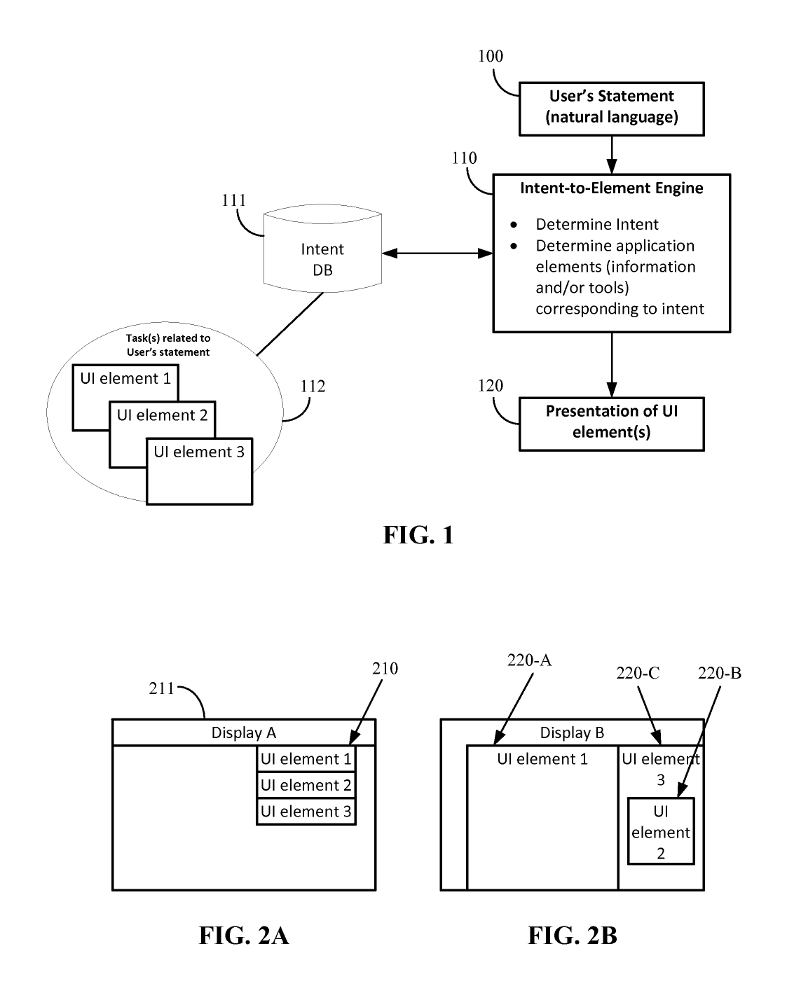

FIG. 1 illustrates a functional diagram for an intent-based user experience; and FIGS. 2A and 2B illustrate example representations of presentations of user interface elements for an intent-based user experience.

Referring to FIG. 1, a user can communicate a goal or intent related to a task that can be accomplished in a productivity application by using a natural language statement (100). The natural language statement can be provided via any technique that enables the user to vocalize, in a manner intuitive to the user, an intention to accomplish a given task or goal in a productivity application. The statement itself can be a statement of a desired outcome, goal, problem, task, or other intent regarding the use of the productivity application such as looking for assistance, researching the web, and completing a task (e.g., “book a meeting”).

Example natural language statements of intent include “make this more beautiful,” “this looks too cluttered,” “turn the page,” “vacation planning,” “I'm going on vacation,” “write a memo,” “organize my notes,” and “make a picture card.” As illustrated by these examples, the user's statement can be effectively anything that can be articulated and that may involve using an application (for creation and/or organization of content), and does not require terms directly related to the names of a command or menu item in the application that may be used to accomplish the task (i.e., the command name or synonyms of the command name).

The user's natural language statement 100 can be received by an intent-to-element engine 110 that can determine the “intent” of the natural language statement and determine the application elements (information and/or tools) that correspond to the intent. The user does not need to understand the parameter structure of the particular application in which the user is working. Rather, the intent-to-element engine 110 can provide a layer between the user and the underlying application or applications.

The intent-to-element engine 110 may convert the natural language statement to user interface elements corresponding to the intent conveyed by the natural language statement by accessing an intent database 111, which may include structured information mapping tasks related to the user's statement to particular user interface elements 112.

The natural language statement may be converted to the user interface elements by analyzing the natural language statement for possible relevant tasks that can correspond to the natural language statement; and retrieving the one or more user interface elements associated with the possible relevant tasks using the intent database 111. As one analysis technique, the natural language statement of intent may be parameterized, for example via clustering techniques.

Thus, in response to receiving the user's natural language statement of intent 100, the intent-to-element engine 110 can generate user interface elements that can be presented to the user 120 in order to help the user accomplish the task associated with the determined intent. Advantageously, certain implementations can include exposing features of the underlying productivity application that the user may not know about or may not be able to access directly. For example, disabled commands (context sensitive commands that are available based on specific object selections), new commands, related commands, commonly used commands, and recently used commands may all be surfaced as part of a result set for a given intent.

User interface elements 112 may be obtained from a single application or from multiple applications, including but not limited to a word processor, spreadsheet, presentation design application, photo editing tool, email application, task tracking application, personal information manager, graphic design program, desktop publishing tool, or web browser. Example applications include Microsoft Word®, Evernote®, Adobe Photoshop®, Microsoft Outlook®, and Google Chrome®. The application(s) may be resident on the user's device, be resident on a cloud service and remotely rendered to the device display, or any combination thereof. The application(s) may also be rendered within a web browser.

Certain implementations utilize an intent mapping service that can classify a user's intent from a received natural language statement of intent and then provide relevant interface elements (including tools and information) that can be used to carry out the intent(s). The intent mapping service may access external information from websites, usage data from multiple users via a collection service, and contextual information gathered from the user's usage habits, network location, or other sources when carrying out its functions.

Because the user interface elements can be presented in response to receipt of a user's natural language statement (or at least some part of the user's natural language statement of intent), the user interface for the productivity application can be considered to be a task-oriented reconfigurable interface. That is, the user interface (e.g., the graphical user interface) for a productivity application can be configured and reconfigured based on a current natural language statement of intent.

As prediction techniques become further developed, some productivity application menus can include predictive command surfaces. Such predictive command surfaces can also be included in the task-oriented user experience. Thus, not only can a user's stated task, goal, or other natural language statement of intent affect the presentation of the user interface and available commands, but the context in which the user is making the statement can be taken into consideration to predict the next one or more commands or information that the user may desire.

The user interface element(s) can be presented to the user in a variety of ways depending on the particular implementation. For example, as illustrated in FIG. 2A, the user interface elements can be presented as a dropdown menu or list 210 in a productivity application interface 211. As another example, as illustrated in FIG. 2B, the user interface elements mapped to the intent (e.g., elements 220-A, 220-B, 220-C) may make up the entire productivity interface for the user, providing elements such as a composition surface, task or menu pane, and information or tools.

User interface elements provided to the user (and which may be mapped to achieving a particular task or other determined intent) can include discrete application commands; user input devices like text input boxes, buttons, menus, dropdown menus, ribbons, or other controls known in the art; or even assemblages of user input devices comprising controls or menus that have been dynamically arranged into a user interface. “Information” might include articles from the application's help file, how-to videos published by the application or located on a website, encyclopedia articles, research results, search results, content from a company knowledge management system or intranet, website content, search results, or any other content which has been determined by the intent mapping service to be relevant to the user's intent.

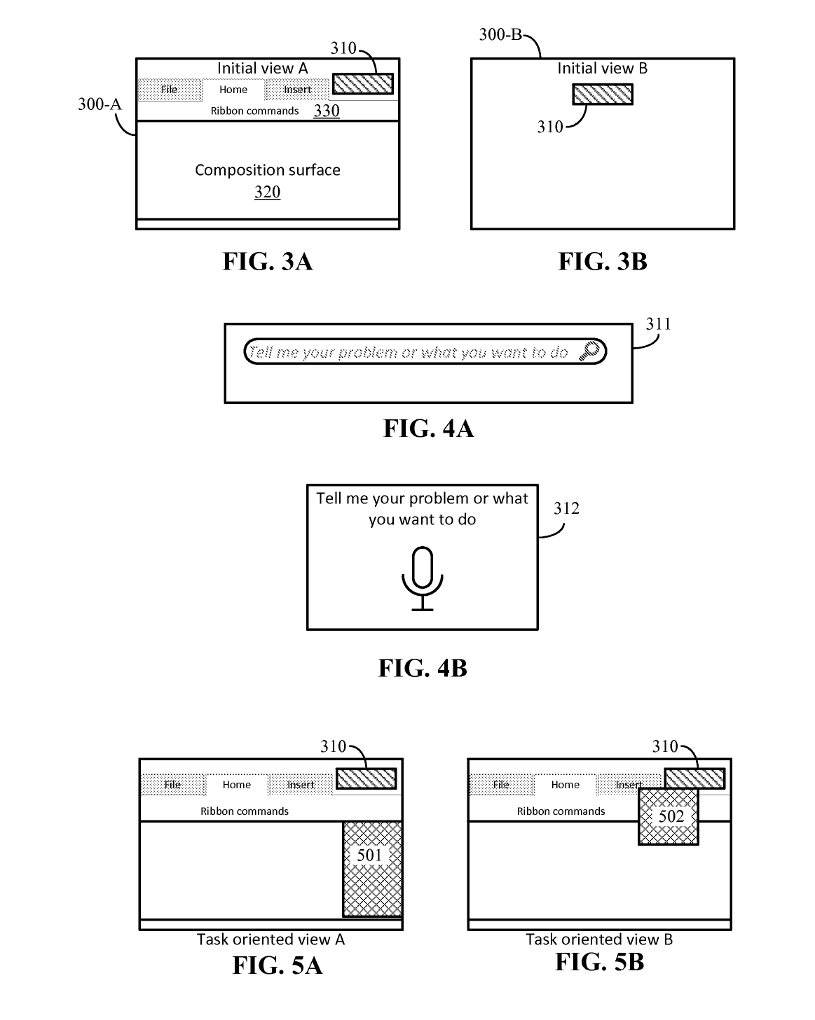

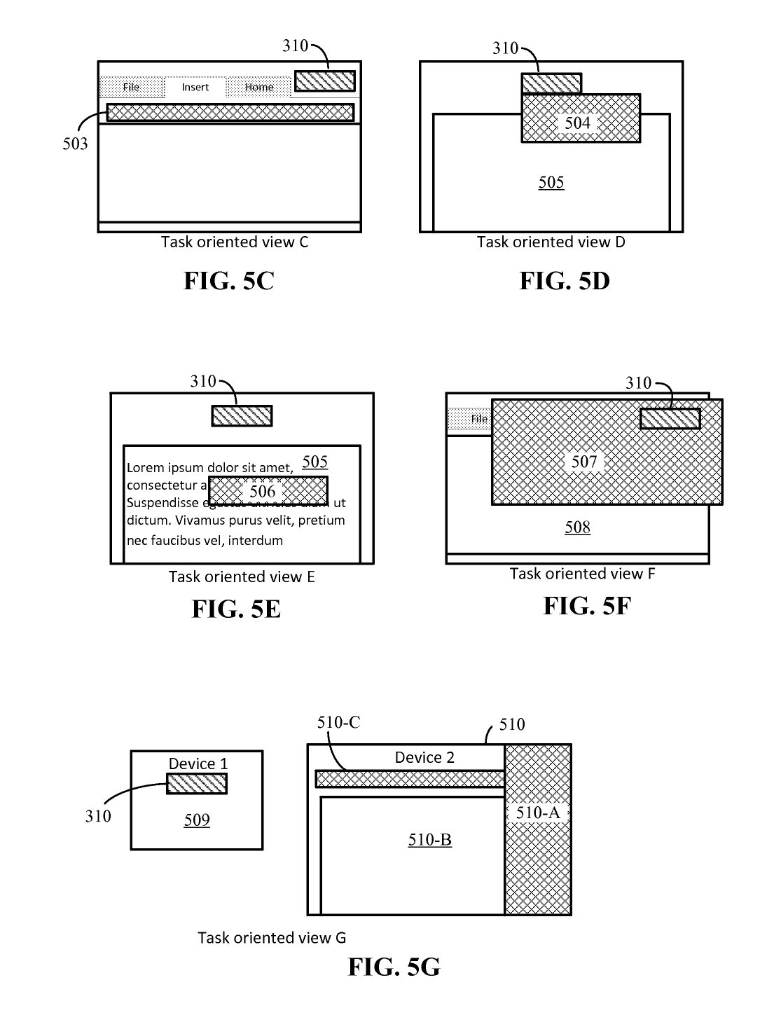

FIGS. 3A and 3B illustrate example initial views for implementing a task-oriented user interface for an intent-based user experience; FIGS. 4A and 4B illustrate example interaction elements for receiving a natural language statement of an intent; and FIGS. 5A-5G illustrate example views of a task-oriented user interface surfaced in response to receiving a natural language statement of intent.

The task-oriented reconfigurable interface can appear similar to more traditional graphical user interfaces available for a productivity application but with the addition of a pane, window, dropdown menu, box or other graphic element. While in other cases, the task-oriented reconfigurable interface can be rendered entirely based on the elements relevant to a user's determined intent.

Referring to FIG. 3A, one initial view 300-A may include features expected in a user interface for a productivity application with the inclusion of an interaction element 310 for receiving a natural language statement of intent. For example, a composition surface 320 and ribbon commands 300 may be rendered as part of the user interface.

In another implementation as shown in FIG. 3B, the initial view 300-B may appear as a blank or otherwise clear canvas or window with the interaction element 310.

The interaction element 310 may be implemented in any suitable manner to indicate the input of a natural language statement of intent. For example, a text box input field interaction element 311, such as shown in FIG. 4A, may receive text input via keyboard, keypad, touchpad, pen/stylus, or other input device. As another example, such as shown in FIG. 4B, a voice input interaction element 312 may be provided.

Once the natural language statement of intent is received, one or more user interface elements relevant to carrying out the user's intent may be surfaced. FIG. 5A illustrates a panel 501 that may surface over or beside the productivity application interface. FIG. 5B illustrates a drop down menu 502 that may surface from the interaction element 310. FIG. 5C illustrates a ribbon element 503 that may surface in the productivity application interface (and which may provide one or more tools for accomplishing the intended task—where these tools may also be available through the traditional menus but not necessarily in the same grouping).

FIG. 5D illustrates an example where a menu 504 may drop down from the interaction element 310 and an interaction surface 505 may also be rendered for generating content in response to receiving a natural language statement of intent from the initial view 300-B as an example. FIG. 5E illustrates a similar example, but where a floating menu 506 may surface along with the interaction surface 505.

FIG. 5F illustrates an example where the task-oriented interface is a separate window (or floating toolbar) that opens over the productivity application interface and includes a user interface element portion 507 and the interaction element 310. FIG. 5G illustrates an example where the task-oriented interface is implemented cross-device. In the example shown in FIG. 5G, one device 509 can be used to receive input via the interaction element 310 while a second device 510 can surface the user interface elements. Example user interface elements include one or more of a panel 510-A (with tools and/or information), composition/interaction surface 510-B, and ribbon or menu tools and/or information 510-C.

The disclosed systems and techniques allow a user to phrase a task intention of greater or lesser granularity that is then translated into pertinent application features by an intent mapping service. In some cases, a slot filling paradigm may be included. For example, a slot, or input field, may be provided as part of an intent extracting dialog. A spell-check may also be included. The intent mapping service may curate the intent into features in a variety of ways described herein. In some embodiments, more complex user interface surfaces may even be built to simplify access to the features. The disclosed techniques may make application usage easier for all users, make applications easier to use on devices with small displays or touch displays (e.g., device displays where certain menus and/or ribbons may take too much space), and improve accessibility for users with many kinds of impairments.

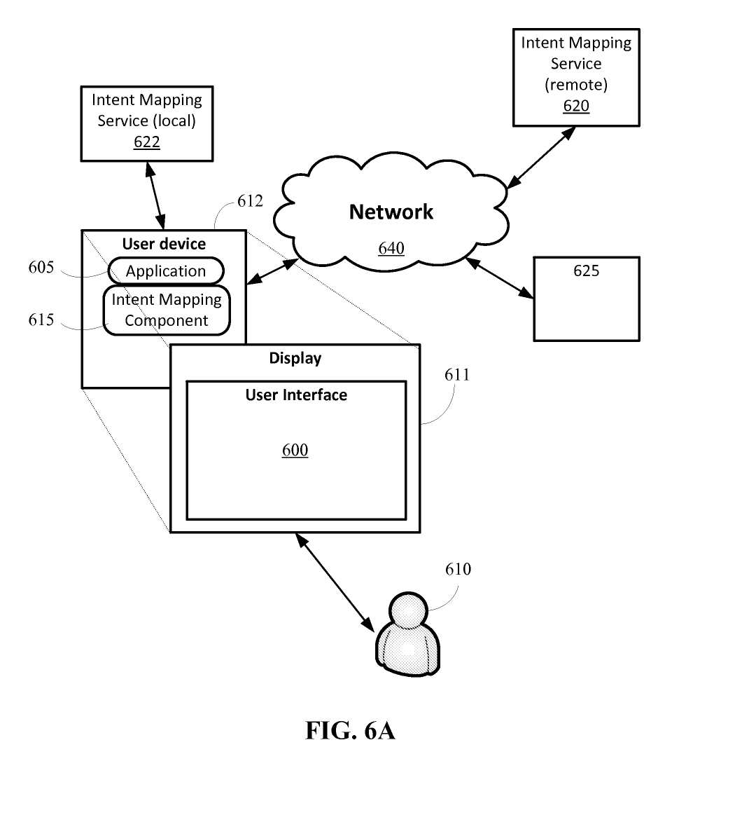

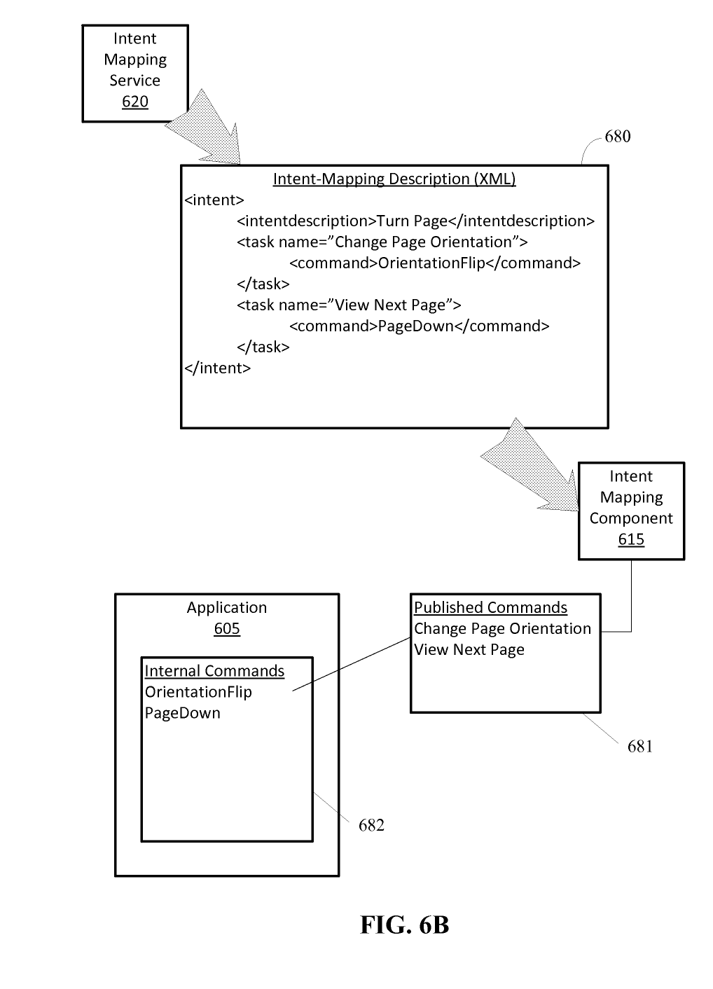

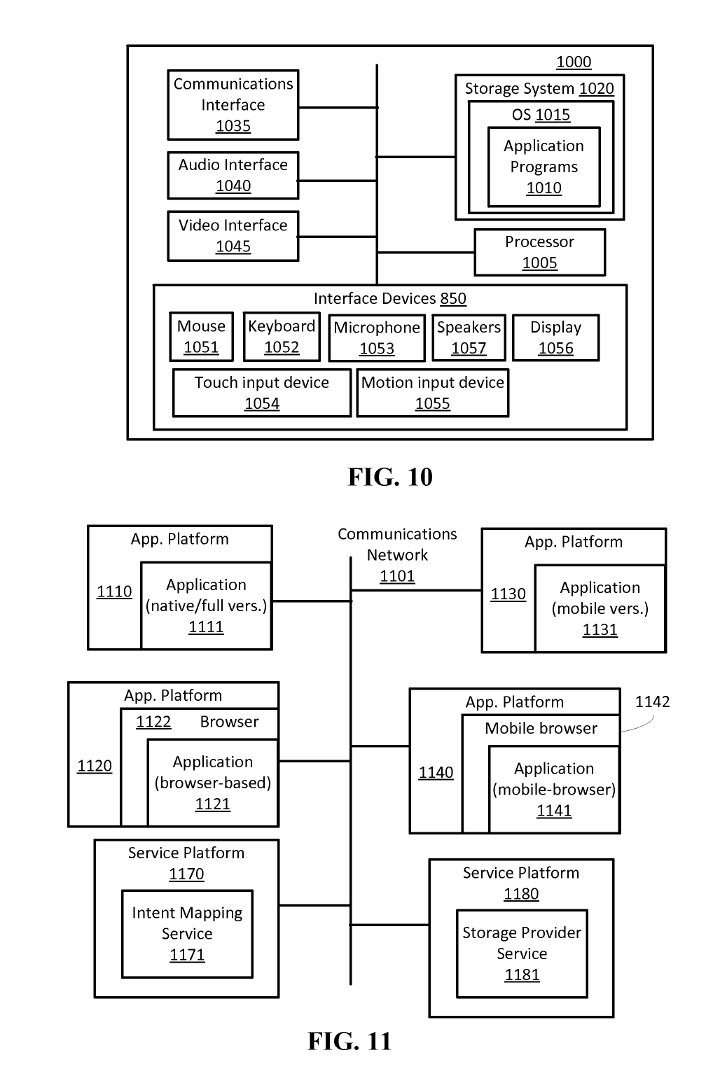

FIG. 6A illustrates an operating environment in which certain implementations of an intent mapping experience may be carried out. In FIG. 6A, a user interface (UI) 600 of an application 605 in which a user 610 is working can be rendered on a display 611 of a user device 612. The application 605 may run directly on the user device 612 or via a browser running on the user device 612. The user device 612 may be, but is not limited to, a personal computer, a laptop computer, a desktop computer, a tablet computer, a reader, a mobile device, a personal digital assistant, a smart phone, a gaming device or console, a wearable computer with an optical head-mounted display, computer watch, or a smart television, of which computing system 1000, discussed below with respect to FIG. 10, is representative.

The UI 600 can be configured and/or influenced by an intent mapping component 615 of the application 605. The intent mapping component 615 may be in the form of one or more software modules that can be called (or invoked) by the application 605. The intent mapping component 615 may provide instructions to carry out one or more of the methods for facilitating the intent-based user experience described herein.

A user's intent or goal may be indicated through an interaction element associated with the application 605. An intent or goal description, at its simplest level, might be all or part of the name of the desired feature. However, more robust descriptions of intent are anticipated in most embodiments, often including a natural language description of a task or goal the user wants to accomplish that spans multiple application commands or features. The user's intent may be described in a number of ways, e.g., typed in as text, spoken as a voice command, or selected from a list. In some embodiments, intent might even be non-verbalized, such as when an application recognizes that the user repeatedly selects “undo” after several actions, indicating that the user is confused about how to perform a task. Here, this intent may be described as “vocalized,” but it should be noted that use of this term is not intended to limit intent-statements to speaking.

The intent mapping component 615 can facilitate the mapping of a natural language statement of intent to a particular task (or tasks) and corresponding user interface elements that may be useful in carrying out that particular task (or tasks).

Interpreting the user's intent and matching it to features and information may be accomplished using a variety of techniques. In some embodiments, the text of a natural language intent statement may be sent through the UI 600 to a software layer which performs the activity of determining the user's intent and mapping the user's intent into features and information relevant to accomplishing an intended task.

This software layer can be an “intent mapping service” 620, 622. It should be noted that all or part of the intent mapping service may be resident on the user's computing device, distributed across multiple machines, or even resident on a cloud service. The singular “intent mapping service” may, in fact, be composed of multiple sub-services in communication with one another. The physical location of the intent mapping service or its constituent sub-services will vary by implementation.

In some implementations, a remote intent mapping service 620 may be used. Some aspects of the intent-based user experience are performed on the user device 612 and rendered for display in the user interface 600, while other aspects may be performed, at least in part, by intent mapping service 620, 622.

Various types of physical or virtual computing systems may be used to implement the intent mapping service 620, such as server computers, desktop computers, laptop computers, tablet computers, smart phones, or any other suitable computing appliance. When implemented using a sever computer, any of a variety of servers may be used including, but not limited to, application servers, database servers, mail servers, rack servers, blade servers, tower servers, or any other type server, variation of server, or combination thereof.

The intent mapping component 615 may interact with the intent mapping service 620 over a network. The network can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

In certain implementations, the intent mapping component 615 facilitates the interaction between a user 610 interacting with the UI 600 and the intent mapping service 620 using an application programming interface (API) of the intent mapping service 620.

In some implementations, a local intent mapping service 622 may be used instead of a remote intent mapping service 620. The local intent mapping service 622 may provide a layer on the user device 612 that enables the user's natural language statement of intent be interpreted into user interface elements from one or more applications. The intent mapping component 615 facilitates the interaction between a user 610 interacting with the UI 600 and the intent mapping service 622 using an API of the intent mapping service 622.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

An API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic.

The API-calling component may be a local component (i.e., on the same data processing system as the API-implementing component) or a remote component (i.e., on a different data processing system from the API-implementing component) that communicates with the API-implementing component through the API over a network.

It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API and related components may be stored in one or more machine-readable storage media (e.g., storage media such as hard drives, magnetic disks, solid state drives, random access memory, flash, CDs, DVDs and the like).

In response to receiving particular user interactions with the UI 600, the intent mapping component 615 may facilitate a call (or invocation) of an intent mapping service 620 (or 622) using the API of the intent mapping service 620 (or 622). The intent mapping service 620 (or 622) can then perform a determination of the user's intended goal or task as well as a determination of the application user interface components that may be relevant to that intended goal or task based on information provided by the intent mapping component 615.

The intent mapping service (620, 622) can determine the task(s) associated with the user's natural language statement of intent, for example by matching the statement of intent with one or more possible tasks that may have been fitted to tools and information available through the productivity application (and/or other applications). Since the user's description of his desired task may begin with a natural language statement, in some embodiments, natural language processing may be used by the intent mapping service (620, 622) to match the user's statement with various possible matching intents.

For example, suppose a user vocalizes the intent to “make this paper a legal document” in a word processing application. The intent mapping service may determine that the user's intended task includes “changing the page size” with relevant features that could enable (and/or inform) the user to change the paper size from “letter-size” to “A4”. However, other relevant features may be changing the margins of the page, rotating the orientation from portrait to landscape, and switching to a different printer which has A4 paper in it. These tools may all be presented to the user as part of the task-oriented user interface.

In some implementations, the intent mapping service may utilize an internet search engine or the search engine of an online help website to return common user intents or the most popular intents for the application.

In some implementations, the intent mapping service (620, 622) may utilize usage data collected from other users of the application. The intent mapping service 620 (or 622) may communicate with usage data service 625, which collects and processes usage data for one or more users, in order to return additional user interface elements that may be relevant to the intended task.

A usage data recorder may be resident on the user's device or elsewhere and may function to record the types and frequency of user behaviors and in some cases upload the usage data to a centralized processing service (which may be part of the usage data service 625) that tabulates usage patterns for large numbers of users. This data may be queried by the intent mapping service 620, 622) as an additional factor to interpret the user's stated intent and match it to known intents.

Any or all of the aforementioned techniques may be used by the intent mapping service to match the user's vocalized intent to application-capable intents. Additionally, in any or all of these models, individuals behind the scenes may editorially select the available intents, for example, by selecting out the most complete intents from authoritative sources. FIG. 6B, described in more detail below, illustrates an example implementation enabling a generalized model for an application to publish its available intents and interface elements. Ultimately, user interface elements that match the task may be returned to the UI and displayed to the user.

The determined user interface elements can be returned to the user device 612 (e.g., destined for the intent mapping component 615). The intent mapping component 615 can then surface elements in the UI 600 based on the information received from the intent mapping service 620.

In some implementations, additional information can be used to facilitate the determination of the user's intent and/or generate additional user interface elements that may be useful. The additional information may vary by case, but, in some embodiments, can include information such as the application state (including the state of the user interface in the application). For example, if the application is a word processor, a relevant user interface state might include the fact that a single word is selected in the interface instead of an entire paragraph, since the features and information that are helpful in accomplishing a given user intent may be different for a word and a paragraph.

Other forms of additional information may include a history of the intents the user has requested in the past. It may also include a history of the types of features and functions the user typically invokes. Intent may be compared with or searched against a social graph or other graph based on the Open Graph standard or even against online polls or other active aggregated feedback. Additional information may also include the type of user, e.g., whether the user is working from inside a corporate network or from outside. In the former case, the user's intent is likely more work-oriented, in the latter more consumer-oriented. For example, the user's vocalized intent to “format a letter” or “prepare a letter” can include certain information or tools based on whether the letter is being prepared as a business letter as opposed to a personal letter. For example, a business letter may follow a set format (and include form letters), so information or tools related to the generation of multiple letters of a same style or even substance could be helpful. In contrast, a personal letter may benefit from tools and information related to preparing cover letters for resumes or alternatively, holiday or birthday card tools.

Furthermore, some of the additional information (and/or other information and metadata not mentioned) may be used to generate predictive commands and/or elements, which can be surfaced along with the user interface elements selected based on the user's natural language statement of intent.

As mentioned above, the mapping service may perform the mapping of intents to features and information in a number of ways, varying by embodiment. In some embodiments, a high-level intent-to-feature mapping language may be utilized to describe and publish intents and their corresponding features and information. Using methods common in the art, such as XML data following a defined XML schema (XSD), various natural-language intents may be matched to an application's relevant commands.

As shown in FIG. 6B, intent mapping component 625 may receive XML 680 from intent mapping service 620. Intent mapping component may be available as a standardized OS feature in some implementations. The intent mapping component 625 processes the XML description by reading the relevant task descriptions and matching the features to their common, callable names within the application.

In some embodiments, application developers may “publish” commands in their applications using a standardized set of command publishing interfaces 681. In this way, internal commands 682 become accessible to outside callers for intent-based mapping. It should be noted that many applications already expose APIs or “object models” which allow other applications or services to perform or “call” operations from a programming language, scripting language, or macro language. Microsoft Word®, for example, exposes most of its features to manipulate Microsoft Word® document files through the Word Object Model.

Commands and features that the application developer wishes to make available for task mapping may be defined according to a standardized interface model for publishing features available to the intent-based user experience. An example of an interface definition model is shown in FIG. 6B, depicting a simple command “change page orientation” matched to its application internal function name “orientation flip.”

It should be noted that in the example illustrated in FIG. 6B, the intent mapping component 625 is generally callable through the OS and is not necessarily controlled by the application. This illustrates a more generalized model for displaying an intent interaction surface, wherein the intent may be vocalized from outside the interface of a given application, but still is capable of calling commands within one or more applications.

In embodiments where more complex user interface elements are to be displayed on the dynamic interface surface, the application developer may combine commands and interface elements into customized interface elements and publishes them using the XML-based techniques described above. Methods of defining application specific “custom” interface elements are known in the art and can be performed in accordance with existing specifications.

In some embodiments, intents may be specifically defined by the application developer to map to application functions. However, using the intent-to-feature mapping language described above, it is also envisioned that third parties may develop intent-to-feature descriptions. Those third parties might include individuals participating in an internet forum, blog, website, or in a social media environment. The individuals might also include experts for hire on web exchanges, who might sell intent-to-feature mapping descriptions to users in need of help on complex tasks. The individuals might even be the employees of a company tasked with defining the intent-to-function mappings for a line of business task specific to that company.

As noted above, in addition to application features, the intent mapping service may also return information that the user might find useful in accomplishing the task. This information might include a descriptive help document from the application's help file. It also might include a web page that describes how to perform a complex operation in more detail. It also might include a video file available on a website that visually shows the user how to perform the operation. Such informational sources may be described in the mapping language or compiled by the intent mapping service using web searches or other methods.

Scenarios:

The following example scenarios are presented to provide a greater understanding of certain embodiments of the present invention and of its many advantages. The following example scenarios are simply meant to be illustrative of some of the applications and variants for embodiments. They are, of course, not to be considered in any way limitative.

In some scenarios, the task-oriented interface may involve a simple text window which, in response to receiving a statement of intent, populates a list of possible intents, each with a sub-listing of relevant application functions and other information that assist in accomplishing the user's goal.

Other scenarios may surface more sophisticated interaction surfaces that enable the user to vocalize intents which may entail multiple applications and/or more complex user input devices.

### Example Scenario A

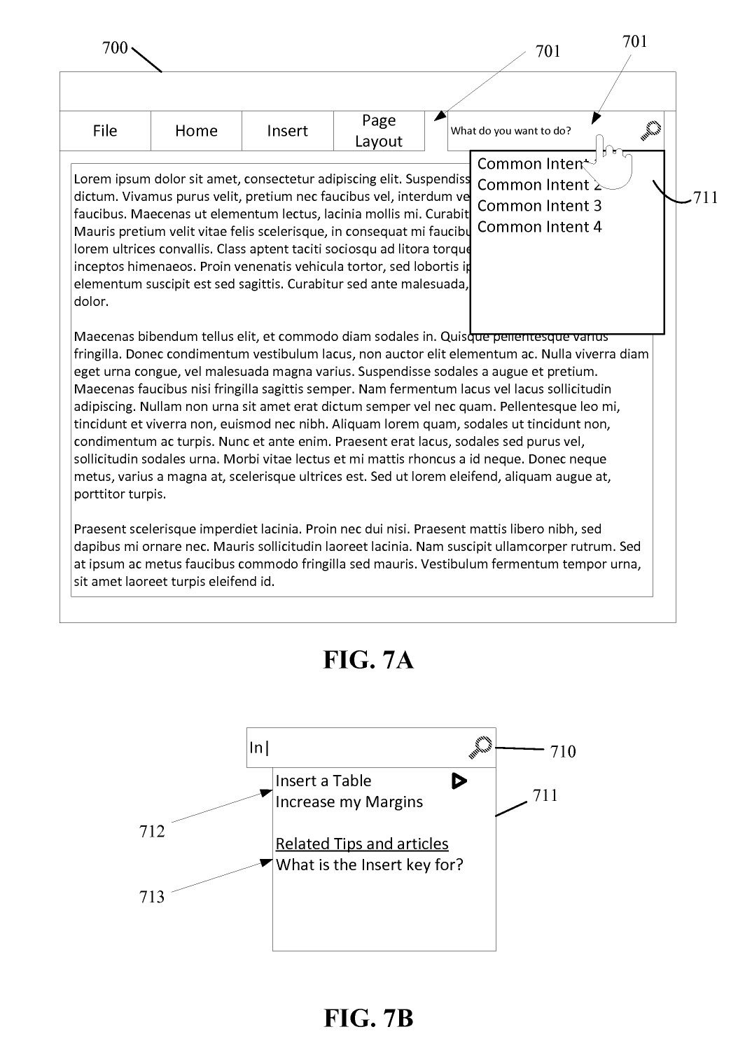

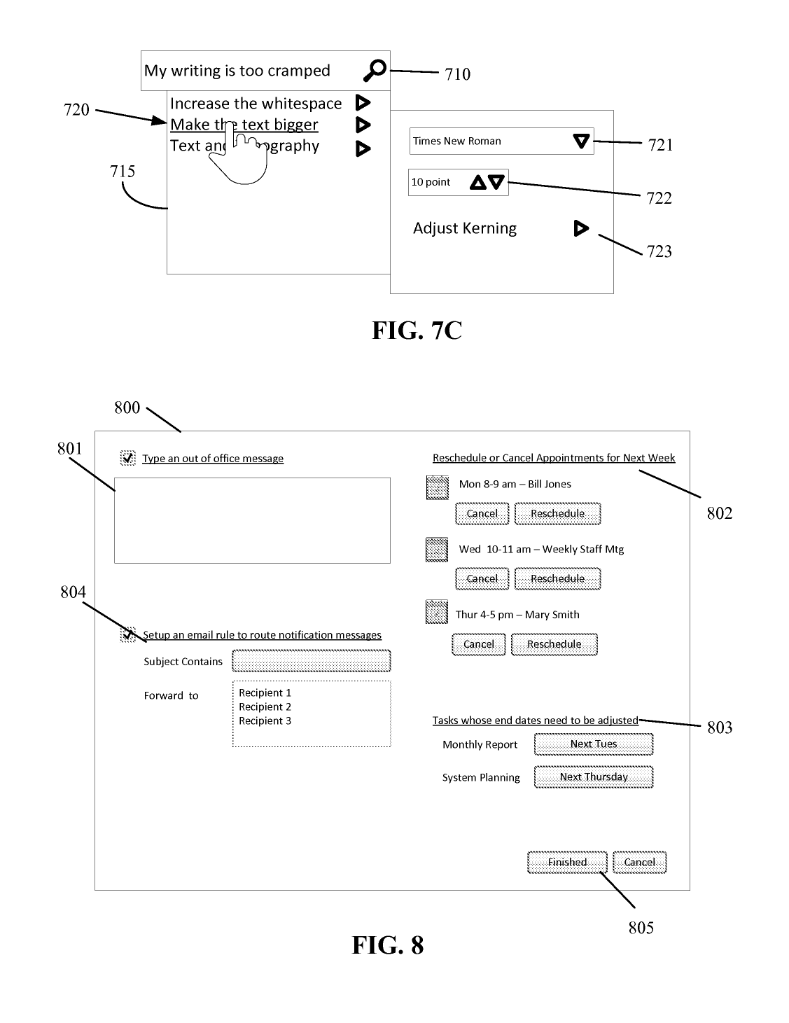

In the example depicted in FIGS. 7A-7B, a word processing application interface 700 is illustrated. In the main menu area 701 of the application, an interaction element 710 containing a text box allows the user to type a phrase expressing a statement of intent. In the example in 7A, clicking in the box may surface a selection list 711 containing a cross section of common intents, features, and information. This list may be populated based on the user's individual usage data, common search queries about the application, commonly used commands as calculated by a usage data collection service, newly released commands in the latest version of the application, or a combination of any or all of the above.

As the user begins to type in the text box, depicted in FIG. 7B, the letters can be used by the intent mapping service to narrow the list of intents. As shown, typing the letters “in” into the interaction element 710 may begin to populate the list 711 with possible relevant commands 712 and information 713. In the example, “insert a table” and “increase my margins” might be two possible feature sets of interest in a word processing application. Also depicted in the example is a list of related informational tips and articles (information 713). Clicking on a command 712 or information 713 source with a mouse, touch gesture, or other suitable interface method activates the item from the list.

### Example Scenario B

The example depicted in FIG. 7C depicts a user entering a natural language statement of intent that returns a group of further intents and feature sets. Here, the natural language statement of intent input to the interaction element 710 is phrased as a “problem” to be solved—the writing looks too cramped to the user of a word processing application. Various “solutions” to remedy the user's “problem,” grouped as feature sets, are suggested by the intent mapping service and surfaced, for example as part of a list 715. The solutions may themselves be used to help determine the user's intent, and a selection of a solution can result in a command or information that may be useful to accomplish the task.

Each feature set is itself selectable. In the example, the user decides to make the text bigger 720, which opens a further interaction surface containing a command group with a variety of interface elements. One interface element allows the user to select, using a dropdown selection list, a new font face 721 which may be more pleasing to the eye. Another input device, an up/down “spinner” control, allows the user to increase the size of the font 722. A third, which itself surfaces a further interface containing commands, allows the user to adjust the text's “kerning,” or the white space between each individual character 723.

### Example Scenario C

A user of a personal information management (PIM) application (which organizes email, tasks, calendar, and contacts) is going on vacation. The user types or speaks “I am going on vacation next week” into the interaction element (not shown) for the PIM. Various temporal expressions may be used and understood by the system, for example through fuzzy calendaring (or fuzzy temporal associations). The interaction element may be on the same or different device as the interface for the PIM. A task-oriented user interface 800 for the PIM can surface to present the commands, functions and information so that the user can prepare for going on vacation.

In this scenario, user interface elements that may surface in response to receiving the user's natural language of intent include a box 801 in which the user can type an out-of-office message, a list of appointments (802) to be rescheduled or cancelled, a list of tasks (803) whose due dates need to be changed, and user input elements for setting up a rule where emails from certain senders can be re-routed to a backup person (804). Each of these application features may be part of a PIM, but in a typical PIM are only accessible by switching to entirely different segments of the application, each with its own command structure. In some cases, user interface elements can include those to facilitate disambiguation of ambiguous intents or “fuzzy” intents (e.g., “dinner” may relate to features and tasks too numerous to present and which cover many different aspects related to dinner).

In some implementations, the task-oriented user interface surfaces in a window over the more traditional PIM user interface; thus, clicking the “Finished” button 805 could complete the requested functions, removing the dynamic user interface and returning the user to his or her prior interface surface.

### Example Scenario D

Scenario D further illustrates the power of the disclosed techniques in a multiple-application model. In this scenario, a user receives a reminder notification from a PIM that an important contact's birthday is upcoming. Some options for tasks related to this reminder can be included in an interaction element for an intent-based user experience. For example, anticipating the user's likely next intents from the context of the birthday notification, the PIM processes likely intents and suggests that one response might be to “make a birthday card” for the contact.

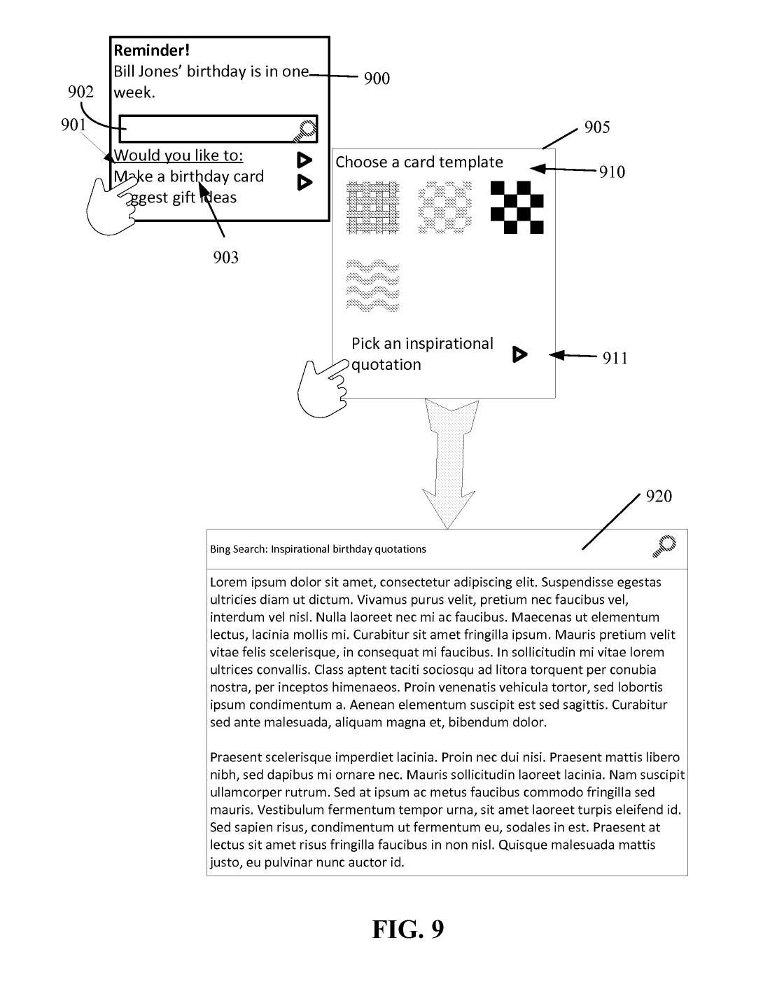

FIG. 9 illustrates an example interface implementing Scenario D. A reminder message 900 surfaces as part of the PIM's normal reminder display model. The reminder message can include tasks 901 that are selectable by the user or can include an interaction element 902 in which the user may indicate a natural language statement of intent.

When the user selects (or inputs a natural language statement) “make a birthday card” (903), one or more user interface elements of the PIM (or other accessible application) related to the task of making a birthday card may surface in a window or pane 905 (or other container). One possible user interface element includes features enabling the selection of a template 910 for a birthday card, which may be available through a word processing or publishing application. Another user interface element may enable a second application to be invoked. For example, “pick an inspirational quotation” 911 can enable the user to access a different application, such as a search engine, which may be accessible through communications between the first application (the word processing application) and a search engine service or through a third application of a web browser.

In one implementation, a selection of “pick an inspirational quotation” 911 may provide a dropdown menu of quotes (or commands related to getting an inspirational quotation). In another implementation, the selection of “pick an inspirational quotation” 911 can bring up a web browser 920.

### Example Computing Environment

FIG. 10 shows a block diagram illustrating components of a computing device used in some embodiments (e.g., user device 612). System 1000 may be implemented within a single computing device or distributed across multiple computing devices or sub-systems that cooperate in executing program instructions. System 1000 can be used to implement myriad computing devices, including but not limited to a personal computer, a tablet computer, a reader, a mobile device, a personal digital assistant, a wearable computer, a smartphone, a laptop computer (notebook or netbook), a gaming device or console, a desktop computer, or a smart television. Accordingly, more or fewer elements described with respect to system 1000 may be incorporated to implement a particular computing device.

System 1000, for example, includes a processor 1005 which processes data according to the instructions of one or more application programs 1010 interacting with the device operating system (OS) 1015. Examples of processors 1005 include general purpose central processing units, application specific processors, and logic devices, as well as any other type of processing device, combinations, or variations thereof.

The application programs 1010, OS 1015 and other software may be loaded into and stored in a storage system 1020. Device operating systems 1015 generally control and coordinate the functions of the various components in the computing device, providing an easier way for applications to connect with lower level interfaces like the networking interface. Non-limiting examples of operating systems include Windows® from Microsoft Corp., IOS™ from Apple, Inc., Android® OS from Google, Inc., Windows® RT from Microsoft, and the Ubuntu® variety of the Linux® OS from Canonical.

It should be noted that the OS 1015 may be implemented both natively on the computing device and on software virtualization layers running atop the native Device OS. Virtualized OS layers, while not depicted in FIG. 10, can be thought of as additional, nested groupings within the OS 1015 space, each containing an OS, application programs, and APIs.

Storage system 1020 may comprise any computer readable storage media readable by the processor 1005 and capable of storing software (e.g., application programs 1010 and OS 1015).

Storage system 1020 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage medium a propagated signal. In addition to storage media, in some implementations storage system 1020 may also include communication media over which software may be communicated internally or externally. Storage system 1020 may be implemented as a single storage device but may also be implemented across multiple storage devices or sub-systems co-located or distributed relative to each other. Storage system 1020 may comprise additional elements, such as a controller, capable of communicating with processor 1005.

Software may be implemented in program instructions and among other functions may, when executed by system 1000 in general or processor 1005 in particular, direct system 1000 or processor 1005 to operate as described herein. Software may include additional processes, programs, or components, such as operating system software or other application software. Software may also comprise firmware or some other form of machine-readable processing instructions executable by processor 1005.

In general, software may, when loaded into processor 1005 and executed, transform computing system 1000 overall from a general-purpose computing system into a special-purpose computing system customized to facilitate the contextual information lookup and navigation process flow as described herein for each implementation. Indeed, encoding software on storage system 1020 may transform the physical structure of storage system 1020. The specific transformation of the physical structure may depend on various factors in different implementations of this description. Examples of such factors may include, but are not limited to, the technology used to implement the storage media of storage system 1020 and whether the computer-storage media are characterized as primary or secondary storage.

For example, if the computer-storage media are implemented as semiconductor-based memory, software may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be noted that many elements of system 1000 may be included in a system-on-a-chip (SoC) device. These elements may include, but are not limited to, the processor 1005, a communications interface 1035, an audio interface 1040, a video interface 1045, and even elements of the storage system 1020.

Communications interface 1035 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 1015, which informs applications and APIs of communications events when necessary.

Interface devices 1050 may include input devices such as a mouse 1051, track pad, keyboard 1052, microphone 1053, a touch device 1054 for receiving a touch gesture from a user, a motion input device 1055 for detecting non-touch gestures and other motions by a user, and other types of input devices and their associated processing elements capable of receiving user input.

The interface devices 1050 may also include output devices such as display screens 1056, speakers 1057, haptic devices for tactile feedback, and other types of output devices. In certain cases, the input and output devices may be combined in a single device, such as a touchscreen display which both depicts images and receives touch gesture input from the user. Visual output may be depicted on the display 1051 in myriad ways, presenting graphical user interface elements, text, images, video, notifications, virtual buttons, virtual keyboards, or any other type of information capable of being depicted in visual form. Other kinds of user interface are possible. User interface 1050 may also include associated user interface software executed by the OS 1015 in support of the various user input and output devices. Such software assists the OS in communicating user interface hardware events to application programs 1010 using defined mechanisms.

It should be understood that computing system 1000 is generally intended to represent a computing system with which software is deployed and executed in order to implement an application with the contextual information lookup and navigation process flow as described herein. However, computing system 1000 may also represent any computing system on which software may be staged and from where software may be distributed, transported, downloaded, or otherwise provided to yet another computing system for deployment and execution, or yet additional distribution.

FIG. 11 illustrates an application environment 1100 in which an application with the proposed improvements may be implemented utilizing the principles depicted in system 1000 (FIG. 10) and discussed above. In particular, FIG. 11 shows various application platforms 1110, 1120, 1130, and 1140, each of which is capable of communicating with service platforms 1170 and 1180 over communications network 1101 to perform the contextual search and return the relevant results. The application platforms 1110, 1120, 1130, and 1140 may be any computing apparatus, device, system, or collection thereof employing a computing architecture suitable for implementing the application (1111, 1121, 1131, 1141) on that platform.

In some embodiments, the described interfaces and process flow may be implemented within applications designed to view and manipulate textual content. In other embodiments, the functionality of detecting text selections and non-intrusively rendering relevant results according to the described methods may be implemented by the OS or by layered components accessible to the applications via API.

Application 1111 may be considered a full or “native” version that is locally installed and executed. In some cases, application 1111 may operate in a hybrid manner whereby a portion of the application is locally installed and executed and other portions are executed remotely and then streamed to application platform 1110 for local rendering. Non-limiting examples of application 1111 may include productivity (and note-taking) applications such as Microsoft Word®, Evernote®, Microsoft Excel®, and Apple Pages®.

Browser-based application 1121, implemented on application platform 1120, may be considered a browser-based version that is executed wholly or partly in the context of a browser application 1122. In this model, all or part of the programming instructions are executed remotely and the browser 1122 renders the result to the user's device through a visual expression language such as HTML. A non-limiting example of a browser-based application 1121 is the Microsoft Office® Web App Service and Google Drive™. Examples of the browser application 1122 include Google Chrome™, Microsoft Internet Explorer™, and Mozilla Firefox™.

Application 1131 may be considered a mobile application version that is locally installed and executed on a mobile device. In some cases, application 1131 may operate in a hybrid manner whereby a portion of the application is locally installed and executed and other portions are executed remotely and then streamed to application platform 1130 for local rendering. Non-limiting examples of mobile applications 1131 include QuickOffice® HD on the Google Android™ and Apple IOS™ devices.

Application 1141, implemented on application platform 1140, may be considered a browser-based version that is executed wholly or partly in the context of a mobile browser application 1142. In this model, all or part of the programming instructions are executed remotely and the mobile browser 1142 renders the result to the user's device through a visual expression language such as HTML. Non-limiting examples of a mobile browser-based application 1141 include mobile-device-enhanced views of content through Microsoft SkyDrive®, Google Drive™. Examples of the mobile browser application 1142 include Google Chrome™ and Mozilla Firefox™.

The application platforms 1110, 1120, 1130, and 1140 may communicate with service platforms 1170 and 1180 connected by network 1101. Service platforms may deliver a variety of services useful to the application platforms and applications for enabling the intent-based, task-oriented user experience as described herein. For example, service platform 1170 may deliver the intent mapping service 1171 described at length above. Service 1171 may also host remote programming instructions and render their results to applications or browsers on any of the application platforms. The intent mapping service 1171 may be implemented using one or more physical and/or virtual servers communicating over a network.

In addition, service platform 1180 may deliver storage provider service 1181, which enables non-local storage of files or other data which can be utilized by applications 1111, 1121, 1131, and 1141, and by intent mapping service 1171. For example, storage provider service 1181 might be a cloud storage provider, a database server, or a local area network file server. The intent mapping service may contain functionality for searching these storage providers for intent definitions or for informational content and presenting the results as described herein. Non-limiting examples of storage provider services include Microsoft SkyDrive®, Google Drive™, DropBox™, Box™, and Microsoft® SQL Server.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method of facilitating the accomplishment of tasks within one or more applications, the method comprising:
receiving a natural language statement of an intent regarding use of a productivity application;
determining one or more user interface elements corresponding to the intent; and
configuring a graphical user interface using the one or more user interface elements corresponding to the intent.

2. The method of claim 1, wherein determining the one or more user interface elements corresponding to the intent comprises analyzing the natural language statement for possible relevant tasks that can correspond to the natural language statement; and retrieving the one or more user interface elements associated with the possible relevant tasks.

3. The method of claim 1, wherein configuring the graphical user interface using the one or more user interface elements corresponding to the intent comprises surfacing at least one of a tool for accomplishing a task associated with the intent and information for accomplishing the task associated with the intent.

4. The method of claim 1, further comprising surfacing one or more predictive commands with the graphical user interface.

5. The method of claim 1, wherein receiving the natural language statement of the intent comprises receiving at least part of a phrase via an input field of the graphical user interface.

6. The method of claim 1, wherein determining the one or more user interface elements corresponding to the intent comprises using the natural language statement of the intent and at least one of a user type, a user's prior usage history, a state of the productivity application, and the user's history of prior natural language statements of intent.

7. An apparatus comprising:
one or more computer readable storage media; and
program instructions stored on the one or more computer readable media that, when executed by a processing system, direct the processing system to render a reconfigurable task-oriented user interface comprising:
an interaction element for receiving a natural language statement of an intent regarding use of a productivity application; and
one or more interface elements associated with the intent surfacing in response to a determination of the intent.

8. The apparatus of claim 7, wherein the one or more interface elements comprise at least one of a tool for accomplishing a task associated with the intent and information for accomplishing the task associated with the intent.

9. The apparatus of claim 8, wherein the information for accomplishing the task associated with the intent comprises application help content or multimedia content.

10. The apparatus of claim 8, wherein the tool for accomplishing the task associated with the intent comprises a plurality of commands grouped according to the intent.

11. The apparatus of claim 10, wherein the plurality of commands are not found in a same grouping in any menu or tool bar of the productivity application.

12. The apparatus of claim 7, wherein the one or more interface elements comprise a first interface element from a first productivity application and a second interface element for interacting with a second productivity application.

13. The apparatus of claim 7, wherein the one or more interface elements comprise a first interface element from a first productivity application and a second interface element for interacting with a personal information management application.

14. The apparatus of claim 7, wherein the interaction element receives the natural language statement of the intent from a second apparatus.

15. The apparatus of claim 7, wherein the interaction element receives the natural language statement of the intent via an input device of the apparatus.

16. The apparatus of claim 7, wherein the reconfigurable task-oriented user interface further comprises a tool element surfacing one or more predictive commands.

17. A method of facilitating an intent-based user experience, comprising:
displaying an interaction element for receiving a natural language statement of an intent regarding use of one or more applications;
in response to receiving the natural language statement of the intent, sending the natural language statement of the intent to an intent mapping service that classifies the intent and provides an indication of one or more interface elements of the one or more applications that correspond to the intent; and
in response to receiving the indication of the one or more interface elements from the intent mapping service, surfacing the one or more user interface elements in a first menu.

18. The method of claim 17, wherein the one or more user interface elements comprise one or more tools, one or more information, or a combination thereof.

19. The method of claim 17, wherein the one or more applications comprise at least one productivity application, the method further comprising surfacing predictive commands of the at least one productivity application in a second menu.

20. The method of claim 17, wherein the one or more interface elements in the first menu are not also found together in a standard menu of the one or more applications.
